(19) United States
(12) Patent Application Publication
(10) Pub. No.: US 2017/0313933 A1
(43) Pub. Date: Nov. 2, 2017

(54) COMPOSITION AND METHOD FOR REDUCING THE VISCOSITY OF HEAVY OIL

(71) Applicant: EREBOS ENERGY PTY LTD, Brighton, Victoria (AU)

(72) Inventor: Karl Anders Arne SUNDBERG, Windsor (AU)

(21) Appl. No.: 15/526,036

(22) PCT Filed: Nov. 11, 2015
(86) PCT No.: PCT/AU2015/000685

§ 371 Date: May 11, 2017

(30) Foreign Application Priority Data
Nov. 11, 2014 (AU) 2014904520

(51) Int. Cl. C09K 8/82; E21B 43/24; E21B 43/12

(52) U.S. Cl. CPC C09K 8/82; E21B 43/2408; E21B 43/121

(57) ABSTRACT

A composition for reducing the viscosity of heavy oils, comprising a mixture of terpene and petroleum distillate wherein the mixture has a flash point of at least 95° C.

### FIELD

The invention relates to a composition and method for reducing the viscosity of heavy oil.

### BACKGROUND

Reference to any prior art in the specification is not, and should not be taken as, an acknowledgment or any form of suggestion that this prior art forms part of the common general knowledge in Australia or any other jurisdiction or that this prior art could reasonably be expected to be ascertained, understood and regarded as relevant by a person skilled in the art.

The efficient recovery and pumping of heavy oil from oil wells, geological formations, tanks or pipelines is of enormous commercial significance. Many oil wells are abandoned when oil deposits become too heavy to be economically recovered. In other cases oil reserves remain unexploited due to the difficulty and costs associated with the recovery and/or pumping of heavy oils. Oil fields can become extremely viscous due to a heavy concentration of paraffin, asphaltene, or a combination of both and other organics in the formation. Paraffin plugs stop oil recovery completely until they are cleared. Indeed, these deposits can result in reduced oil production, fouling of flow lines and down hole piping and increased pumping costs due to the requirement for high cost pumping equipment and the wear caused by pumping a high viscosity fluid and buildup of deposits in equipment and piping.

Oil wells may also have problems with the buildup of paraffin, sulfur, heavy oil, and tar by-products, which may pose intermittent problems with pumping or transfer of heavy oil. These residues may foul the lines that carry the oil to the surface and foul the pumps, pump lines and tanks used in recovery and transfer of oil from wells.

One method to improve flow of heavy oils involves the use of aggressive blends of low flash point aromatic and/or aliphatic petroleum hydrocarbons or halogenated hydrocarbons. These products may or may not contain surfactants to allow the products to mix with and emulsify in water to increase cleaning efficiency.

Terpenes are commercially available for this purpose and generally have a flash point of less than 50° C. The use of low flashpoint components requires special arrangements to be made for transport and storage due to the flammability classification of such hazardous materials.

With ever increasing environmental pressures being placed on the oil industry it has become necessary to develop and employ products and methods of well treatment which can perform in a timely fashion, be cost effective and conform to the stricter controls now in place.

### SUMMARY

We have found that the combination of certain terpenes and distillates provides a mixture of higher flash point than either component and which is particularly efficacious in reducing the viscosity of heavy oils.

We provide a composition for reducing the viscosity of heavy oils, comprising a mixture of terpenes and petroleum distillate, the mixture having a flash point of at least 95° C. such as in the range of from 95° C. to 125° C. or from 95° C. toll0° C.

The terpene component typically has a flash point of no more than 50° C. such as no more than 40° C.

The distillate composition preferably has a flash point of no more than 85° C.

In a further embodiment we provide a method of reducing the viscosity of heavy oil comprising adding to the heavy oil an effective amount of the composition as hereinbefore described, such as in an amount of from 1% to 50% by volume and preferably in an amount of from 1% to 30% (more preferably from 5% to 25%) by volume of the heavy oil composition.

Throughout the description and the claims of this specification the word “comprise” and variations of the word, such as “comprising” and “comprises” is not intended to exclude other additives, components, integers or steps.

### DETAILED DESCRIPTION

The composition is useful in reducing the viscosity of heavy oil.

There are three general categories of heavy oil:

Heavy oil (Class A) having a viscosity ranging from 10 to 100 cP. Typically oils in this class have specific gravity between 18° and 25 API and.

Extra-heavy oils (Class B) having a viscosity of up to 10,000 cP. Typically the extra heavy oils have specific gravity below 20 API. Oil sands and bitumen (Class C) having a viscosity above 10,000 cP.specific. Typically such oils have a specific gravity in the range of 7° to 9 API.

Oil sands, which term is used herein to include tar sands and bituminous sands, are a type of unconventional petroleum deposit.

Oil sand is either loose sand or partially consolidated sandstone containing a naturally occurring mixture of sand, clay, and water, saturated with a dense and extremely viscous form of petroleum technically referred to as bitumen (or colloquially tar due to its similar appearance, odour and colour). Natural bitumen deposits are reported in many countries, but in particular are found in extremely large quantities in Canada.

The composition comprises an aliphatic petroleum distillate. The aliphatic distillate preferably contains C₈ to C₁₆ more preferably C₁₁ to C₁₄, aliphatic hydrocarbons selected from n-alkanes, isoalkanes and cyclic aliphatics. The distillate typically has less than 5% w/w aromatics such as no more than 2% w/w aromatics. The preferred aliphatic distillate has a flash point of no more than 85° C., most preferably about 80° C.

The composition comprises a terpene. The preferred terpenes are selected from the group consisting of monoterpenes, sesquiterpenes and mixtures thereof and are cyclic aliphatics. Specific examples of preferred terpenes may be selected from the group consisting of limonene, α-pinene, β-pinene, camphene, menthene, turpentine, myrcene, β-caryophyllene, and α-humulene, geraniol, terpineol, myrcene and mixtures of two or more thereof. In a particularly preferred embodiment the terpene is limonene such as D-limonene.

The ratio of terpene to distillate may be determined having regard to the specific composition of each and the desire to provide a mixture having a flash point of at least 95° C. such as in the range of from 100° C. to 110° C. Typically the volume ratio of terpene to distillate is in the range of from 80:20 to 20:80, more preferable a terpene:distillate ratio of from 20:80 to 50:50.

In the case of limonene we have found a volume ratio of limonene:distillate of from 20:80 to 50:50 to be particularly useful and more preferable from 25:75 to 45:55. One specific example of a composition contains 35% by volume D-limonene and 65% by volume distillate.

In view of the fact that the flash point of the terpenes is less than 50° C. and generally no more than 45° C. and the flash point of the distillate is generally no more than 85° C. it was surprising to find that the combination of the two components could provide a higher flash point than either. The combination allows the transport and handling of the composition under conditions, which are provided for less hazardous materials than the components, particularly the terpene, and generally allow the compositions to satisfy regulations relating to the transport and handling of less hazardous materials.

The composition may if desired contain other components but it is preferred that the mixture of terpene and distillate constitutes at least 90% and preferably at least 95% by weight of the composition. In one set of embodiments the composition comprises no more than 5% w/w of other materials such as surfactants and components comprising one or more elements selected from sulfur and phosphorus. In one set of embodiments the composition comprises less than 0.02% w/w of compounds comprising heteroatoms such as sulfur, phosphorus, oxygen and nitrogen.

The invention includes a method of reducing the viscosity of heavy oil comprising providing a composition comprising the terpene and aliphatic hydrocarbon and adding to heavy oil in an effective amount of the composition as hereinbefore described. The amount of the composition will be effective to reduce the viscosity of the heavy oil composition. The desired reduction in viscosity will depend on the initial viscosity and the conditions such as pressure and temperature under which the oil is treated in the processes of recovery from the oil well and/or in the pumping process. In one set of embodiments the composition is added in an amount of from 1% to 50% by volume and preferably in an amount of from 1% to 30% (more preferably from 2% to 25%) by volume of the heavy oil composition.

The method may further comprise the recovery of the heavy oil from an oil well and/or the pumping of the heavy oil.

The composition allows the thinning of heavy crude oil in wells and geological formations. The use of the composition in this way may allow recovery of heavy oil, which is not otherwise readily recovered from the well or formation. The composition may be combined with the heavy oil in the well or geological formation.

In one set of embodiments the invention provides a method for pumping heavy oil extracted from an oil well in a geological formation using pumping equipment comprising introducing into said well, formation, or equipment a composition as hereinbefore described.

In one set of embodiments the heavy oil has a viscosity of more than 100 cPs, preferably more than 1000cps and more preferably more than 5000 cPs. In a preferred set of embodiments the heavy oil has a viscosity of at least 5000cPs and the composition is added in an amount to provide a viscosity of no more than 1000 cPs. In one set of embodiments the composition is added to an API specific gravity of no more than 10° and the addition the composition provides and API gravity of at least 20°.

The composition may be used to additionally provide a cleaning effect. Generally speaking the compositions comprising higher proportions of the aliphatic distillate exhibit enhanced cleaning effect. The recovery, pumping and storage of heavy oil is frequently associated with the build-up of residues such as asphaltenes which may interrupt or reduce the capacity for oil recovery or pumping. The composition for reducing build up may be selected having regard to the balance required between viscosity reductions and cleaning of residues. The method of the invention may provide a variation in the proportions of the components to periodically provide cleaning by increasing the proportion of the aliphatic distillate. In general relatively high proportions of the distillate such as 60% to 80% by volume provide most effective cleaning. In a further embodiment the composition is added to pipes to clear a blockage or build-up of residue in a pipe line.

The crude bitumen contained in the Canadian oil sands is described by the National Energy Board of Canada as “a highly viscous mixture of hydrocarbons heavier than pentanes which, in its natural state, is not usually recoverable at a commercial rate through a well because it is too thick to flow.”

Oil sands reserves constitute a considerable part of the world's oil reserves. For example, in Canada oil sands constitute 98% of Canada's 173 billion barrels of proven oil reserves. Oil produced from oil sands is often referred to as unconventional oil or crude bitumen, to distinguish it from liquid hydrocarbons produced from traditional oil wells. About 20% of oil sands are within 75 metres of the surface and can be accessed through mining. The remaining 80% must generally be extracted by drilling and using steam to separate the bitumen type oil from sands (“Oil Sands A strategic resource for Canada, North America and the global market” Government of Canada 2013). Pumping of the bitumen type oil from oil sands remains a significant problem due to the viscosity which may be as much as at least 100,000 cPS, such as at least 200,000 cPs.

In a preferred embodiment the composition is co-injected in to a heavy oil deposit such as oil sands with steam. Without wishing to be bound by theory we believe that steam assisted delivery of the composition provides preferential dissolution of the oil in a vapor of the composition which may result in a much more rapid dissolution of heavy oil, such as the bituminous component of oil sands, In this embodiment is sometimes sufficient to use an amount of the composition of less than 10% on the heavy oil such as less than 6% or even as low as about 2-3% by volume of the oil.

In one set of embodiments the composition is used together with steam in Steam assisted gravity drainage (SAGD). In SAGD, two wells, which are generally approximately horizontal, are drilled in the oil sands, one, preferably at a lower position in the formation and another above it such as about 5 metres above it. In the well pair, steam and the composition are co-injected into the upper well; the heat melts the bitumen and allows it to flow into the lower well, where it is pumped to the surface. In one embodiment the steam and composition are heated to a temperature of at least 120°, such as at least 150° C. or at least 200° C. The boiling point of the composition allows it to transform into a vapour and in this state it is believed to be more effecting in extraction of heavy oils such as bitumen in oil sands.

In a further embodiment the composition is added between the outer casing and production tubing in an oil well to improve flow.

In a further embodiment the composition is added to a pipeline with steam for example by injecting into the interior of the pipeline with steam. Injection with steam may also be used to improve the flow down hole.

Chemical and physical fracking or fracturing of an oil formation is a practice used to open the formation for more oil to flow into a collection reservoir. In one embodiment the composition is used in fracking to provide a more productive flow of oil from the fractured formation. In one set of embodiments the composition is introduced to the fractured formation as a front runner chemical. Early introduction of the composition into a freshly created fracture may allow greater recovery than if used following conventional fracking chemicals

The composition also exhibits excellent demulsifier properties. It may thus be added to a water in oil composition of heavy oil to break an emulsion and provide separation of an oil water mixture which may otherwise be persistent and difficult to separate. Heavy oil containing the composition also generally exhibits a lower propensity to form intractable emulsions when mixed with water. Consequently the use of the composition with steam or aqueous compositions generally allows the oil and water phases to be more readily separated when this is required.

The invention will now be described with reference to the following examples. It is to be understood that the examples are provided by way of illustration of the invention and that they are in no way limiting to the scope of the invention.

### EXAMPLES

Where referred to herein in the specification and claims the following properties are determined as follows:
flash point refers to the flash point determined according to ASTM D92-05a which uses an open cup method;
where referred to herein in the specification and claims, viscosity is determined at approx. 15° C. and refers to Brookfield viscosity.

### BRIEF DESCRIPTION OF THE DRAWINGS

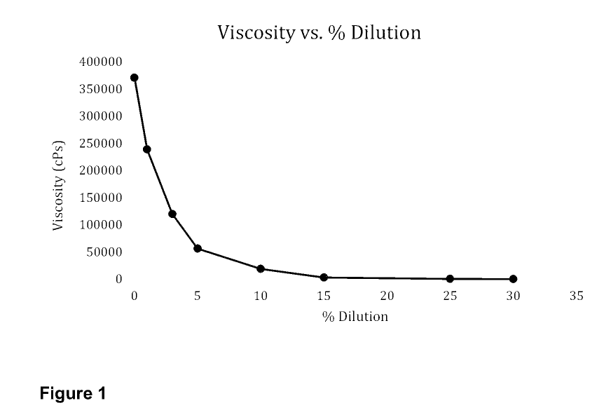

In the drawings FIG. 1 is a graph showing the change in viscosity of a heavy oil of viscosity 371,000 cPs with percent dilution with Composition 1 of Table 1, as described in Example 2.

### EXAMPLE 1

Compositions in accordance with the invention are prepared by combining the components in the amounts by volume set out in Table 1.

TABLE 1

| Composition | Terpene | Aliphatic distillate |
|---|---|---|
| No | (proportion by volume) | (proportion by volume) |
| 1 | d-limonene 35% | 65% |
| 2 | d-limonene 50% | 50% |
| 3 | d-limonene 20% | 80% |
| 4 | d-limonene 25% | 75% |

The aliphatic distillate comprises hydrocarbons, C₁₁-C₁₄, n-alkanes, isoalkanes, cyclics, <2% aromatics; CAS No. 64742-47-8; Distillates (petroleum) hydrotreated light.
The Flash Point of Composition No. 1 was determined by to be 105° C.

The individual components have the flash points shown below:

D80 aliphatic distillate 80° C.

d-limonene 50° C.

### EXAMPLE 2

This example demonstrates the viscosity reduction of heavy oil provided by the composition of the invention.

The heavy oil was sourced from a Canadian oil field and found to have a viscosity of 371,000 cPs. Composition 1 of Example 1 was mixed with the heavy oil and the viscosity was determined for various percentages of the Composition 1 in the heavy oil composition.

The results are shown in Table 2

TABLE 2

| % Comp 1 | Viscosity (cPs | Temperature (° C.) |
|---|---|---|
| 0 | 371000 | 15.5 |
| 1 | 239000 | 14.7 |
| 3 | 120000 | 14.5 |
| 5 | 56388 | 15.7 |
| 10 | 18896 | 14.7 |
| 15 | 3215 | 15 |
| 25 | 661.1 | 15.2 |
| 30 | 278.3 | 16.6 |

The change in viscosity with percent dilution is shown in the graph which is FIG. 1.

1. A composition for reducing the viscosity of heavy oils, comprising a mixture of terpene having a flash point of no more than 50° C. and petroleum distillate having a flash point of no more than 85° C., wherein the composition has a flash point of at least 95° C.

2. A composition according to claim 1 wherein the composition has a flash point in the range of from 95° C. to 125° C.

3. A composition according to claim 1 wherein the terpene is selected from the group consisting of limonene, α-pinene, β-pinene, camphene, menthene, turpentine, myrcene, β-caryophyllene, and α-humulene, geraniol, terpineol, myrcene, limonene, pinene, turpentine and mixtures thereof.

4. A composition according to claim 1 wherein the petroleum aliphatic distillate comprises C₁₁ to C₁₄ aliphatic hydrocarbons selected from n-alkanes, isoalkanes and cyclic aliphatics and less than 5% w/w aromatics.

5. A composition according to claim 1 wherein the terpene is limonene.

6. A composition according to claim 1 wherein the volume ratio of terpene:petroleum distillate is in the range of from 20:80 to 80:20.

7. A composition according to claim 6 wherein the ratio of terpene:petroleum distillate is in the range of from 20:80 to 50:50.

8. A composition according to claim 1 comprising less than 0.02% w/w of compounds comprising heteroatoms such as sulfur, phosphorus, oxygen and nitrogen.

9. A composition according to claim 1, comprising limonene and C₁₁ to C₁₄ petroleum distillate in a volume ratio of limonene: C₁₁ to C₁₄ petroleum distillate of from 20:80 to 50:50.

10. A method of reducing the viscosity of heavy oil comprising adding to the heavy oil an effective amount of the composition as claimed in claim 1.

11. A method for pumping heavy oil extracted from an oil well in a geological formation using pumping equipment comprising introducing into said well, formation, or equipment a composition according to claim 1.

12. A method according to claim 10, wherein the composition is added in an amount of from 1% to 30% by volume of the heavy oil.

13. A method according to claim 10, wherein the heavy oil has a viscosity of at least 1000 cPs at 15° C.

14. A method according to claim 10 wherein the heavy oil has a viscosity of at least 5000 cPs at 15° C.

15. A method according to claim 10 wherein the heavy oil has a viscosity of at least 5000 cPs and the composition is added in an amount to provide a viscosity of no more than 1000 cPs at 15° C.

16. A method according to claim 10, wherein the composition is used together with steam in steam assisted gravity drainage.

17. A method according to claim 10 wherein the composition is introduced to a fracture created in a heavy oil geological formation.
